(19) United States
(12) Patent Application Publication
(10) Pub. No.: US 2002/0069123 A1
(43) Pub. Date: Jun. 6, 2002

(54) Electronic commerce system

(76) Inventors: Mats Soderlind, Stockholm (SE); Jonas Hermansson, Uppsala (SE)

Correspondence Address: Brian D. Walker, Jenkens & Gilchrist, P.C., 3200 Fountain Place, 1445 Ross Avenue, Dallas, TX, 75202-2799, US

(21) Appl. No.: 09/818,170

(22) Filed: Mar. 27, 2001

Related U.S. Application Data
(60) Provisional application No. 60/250,737, filed on Dec. 1, 2000.

(51) Int. Cl. G06F 17/60; G06F 9/00; G06F 9/46

(52) U.S. Cl. 705/26; 709/328

(57) ABSTRACT

A system for enabling the performance of electronic commerce transactions includes a central controller for integrating together a plurality of legacy systems allowing an exchange of data relating to electronic commerce transaction between the central controller and each of the legacy systems. A plurality of application programming interfaces associated with the central controller enables communications between the central controller using a first communications protocol and each of the plurality of legacy systems using a different communications protocol.

### RELATED APPLICATION(S)

This application claims priority from, and incorporates herein by reference, the entire disclosure of U.S. Provisional Application No. 60/250,737, filed Dec. 1, 2000.

### TECHNICAL FIELD

The present invention relates to electronic commerce systems, and more particularly, to a system enabling interaction between legacy components of an electronic commerce system.

### BACKGROUND OF THE INVENTION

The expansion of the Internet has provided businesses and individuals with increased opportunity to perform business transactions (i.e., e-commerce) on a large scale. Today's e-commerce solutions are almost exclusively performed as unique, single implementation systems. A system must be implemented from scratch with no connection or interaction with other types of systems. This can create high implementation costs for individuals attempting to begin their own e-commerce business or for existing businesses expanding their business into the e-commerce realm.

Existing e-commerce transactions are normally classified as one of two types, business to business (B2B) and business to consumer (B2C). The reasons for this are the perceived differences between the functionality of the two tracks. However, there really are no great differences between the two types of e-commerce transactions. Both require strong authentication, connection to an underlying business system and a proven transaction engine. Existing systems are unable to interconnect the separate entities required for an electronic commerce transaction and integrate them into a single viable system. This requires each new e-commerce solution to comprise a unique entity built from scratch. This causes the cost of launching and maintaining a system to be high in terms of initial investment and support.

A merchant wishing to implement a web shop today has two choices. The merchant may host a complete web shop himself, complete with the required business system, access control systems, security systems, transaction systems, etc., or the merchant may outsource the entire operation to an independent service provider. Neither of these solutions are optimal. When the merchant implements the system, the merchant is required to bear the cost of implementing and maintaining the hardware, software and human resources associated with the electronic commerce system. The second scenario, while less costly, is also less flexible for the merchant because all changes in the web shop must be performed by the service provider. The second scenario also limits the amount of current information a merchant is able to obtain with respect to sales on the web shop.

In both of these cases, each consumer and merchant is required to enter into a separate business relationship instead of negotiating a single relationship with a trusted third party. This means that a consumer doing business with ten separate merchants must have ten separate deals, one with each merchant. Therefore, a need has arisen for a system enabling the integration of a plurality of different systems necessary for performing an electronic commerce transaction in such a manner that does not require a complete construction of an electronic commerce system for a new merchant wishing to open a web shop.

### SUMMARY OF THE INVENTION

The present invention overcomes the foregoing and other problems with a system enabling the performance of electronic commerce transactions which includes a central controller for integrating together at least one of business systems, transaction systems, identification systems or presentation systems with the central controller enabling the exchange of data relating to an electronic commerce transaction therebetween. The central controller provides logic to support an e-commerce transaction using the various systems. The solution enables the use of several access and security methods, not just one single method. The solution provides for “multi channel” payments, meaning that a central controller offers to the Merchants one and the same payment solution using different transaction media. Likewise, the Consumers can pay using one and the same payment solution using different transaction media. The solution is transparent to which means of communications is used by vendors and customers. Application program interfaces (API) associated with the central controller enable communications between the central controller and the business systems, transaction systems, identification systems and presentation systems. The APIs include at least a first layer supporting a first communication protocol used by the central controller and a second layer for supporting a second communications protocol used by one of the other systems.

### BRIEF DESCRIPTION OF THE DRAWINGS

A more complete understanding of the method and apparatus of the present invention may be obtained by reference to the following Detailed Description when taken in conjunction with the accompanying Drawings wherein:

FIG. 1 is a functional block diagram of the electronic commerce system of the present invention;

FIGS. 2a and 2b illustrate communications through an API;

FIG. 3 provides a more detailed illustration of the API between the middleware and a legacy system;

FIG. 4 provides an illustration of the various objects stored within the database of the middleware;

FIG. 5 illustrates various logical applications included within the middleware;

FIG. 6 illustrates an example of a browser transaction using the system of the present invention;

FIG. 7 illustrates a mobile SMS transaction using the system of the present invention; and

FIG. 8 illustrates a business to business transaction using the system of the present invention.

### DETAILED DESCRIPTION

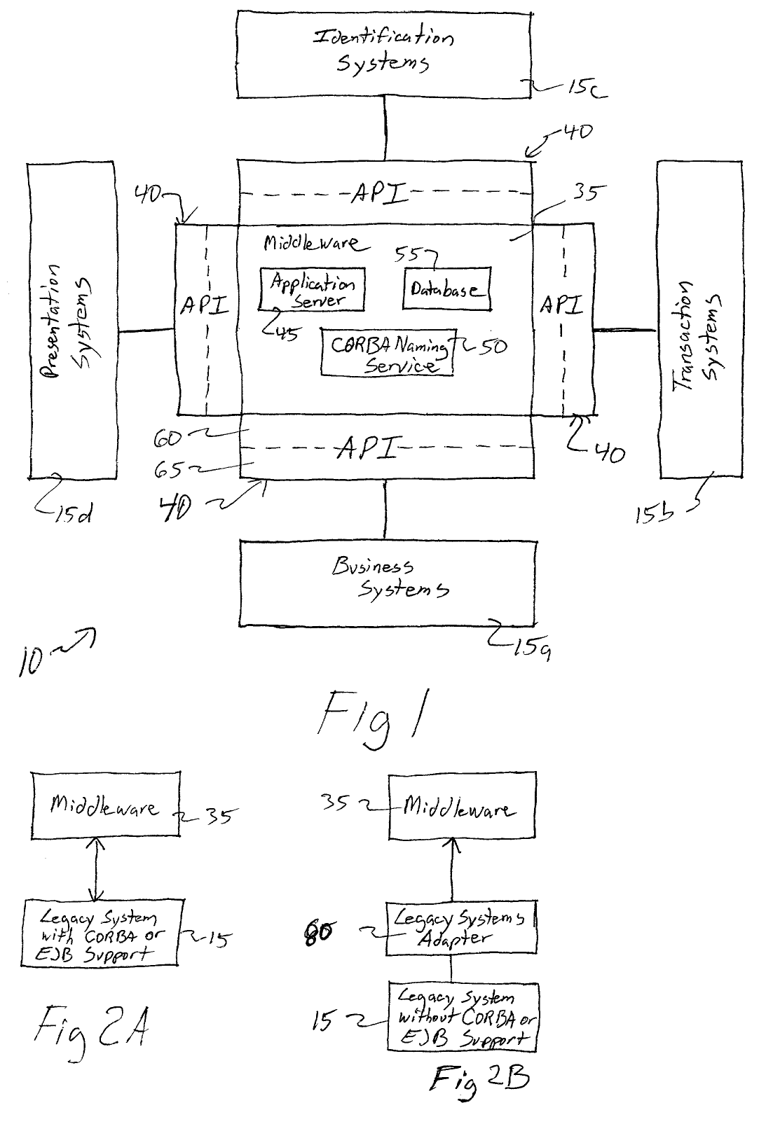

Referring now to the drawings, and more particularly to FIG. 1, there is illustrated an electronic commerce system 10 operating according to the present invention. The electronic commerce system 10 consists of a plurality of legacy systems 15 such as a business system 15a, transaction system 15b, identification systems 15c and presentation systems 15d. The legacy systems 15 interact through a core system 35 referred to as the middleware.

The middleware 35 implements a number of APIs 40 enabling communications between the various legacy systems 15 and the middleware 35. The middleware 35 also implements the core logic of the electronic commerce system 10 controlling how transactions are handled and how information is moved around within the electronic commerce system 10. The middleware 35 comprises an application server with EJB management, covering logic, implementation objects and database activity. The middleware 35 includes an application server 45 which manages the electronic commerce system's 10 internal logic and handles the provision of services amongst the various legacy systems 15. The middleware 35 is able to act as a service binder between each of the legacy systems 15. A call from one legacy system 15 may result in data retrieval from another legacy system 15 or may simply be handled by the core logic of the middleware. A database 55 stores system fundamental data, certificate relationships, names, identification of system members and system objects. All control of transactions are configured with the database 55 within the middleware 35 which is in turn used by the various core logic applications 45. A CORBA naming service 50 assists in controlling the APIs 40 in a IIOP fashion. The CORBA naming service 50 makes external legacy systems visible to the middleware 35, using the APIs 40. The legacy systems 15 include the various systems necessary to perform an e-commerce transaction.

The business systems 15a comprise legacy systems containing invoicing, consumer and merchant data and functionalities. As a practical matter, literally thousands of business systems exist. Most of these are tightly integrated with a company's daily operations and do not support standard protocols for communication with external systems. The transaction systems 15b comprise a set of servers and legacy systems for managing financial transactions. This may consist of a server provided by a bank for a balance/withdrawal/deposit manager. The transaction systems 15b manage financial transactions and keep records of the transactions. The transaction systems 15b handle tasks such as supporting standard APIs for micropayments, managing transactions between an Internet payment provider and a merchant, keeping track of payments and refunds, keeping track of customer's account balances and keeping track of merchant's account balances.

The identification systems 15c comprise software and hardware enabling services to determine whether a consumer or merchant is valid within a particular system. Identification systems 15c also manage the verification of purchases. Various examples of identification services include dial-in caller ID and external identification systems such as customer databases, certificate generators, CID (caller ID) certificate verifiers and CID servers. Verification of purchases may be done using X509 certificates and replies to SMS messages. The presentation subsystems 15d comprise a set of hardware and software servers for offering a graphical user interface to the electronic commerce system 10. For a merchant, the merchant's own web server comprises part of a presentation system 15d. For a customer, their Internet browser would comprise part of the presentation systems 15d. The presentation system servers offer common web based UI (user interface) for merchants and consumers as well as for the administrative personnel like consumer support and administration.

The API 40 enable communications between the middleware 35 and the various legacy systems 15. Each API 40 contains two adaptor layers, enabling the support of two different interface standards. CORBA and EJB adapters 60 enable communication with EJB interfaces and CORBA IDL interfaces. Additionally, adapters using remote method invocation (RMI) and MQ (for mainframes) may also be used. The legacy system adapters 65 comprise small customized modules for each external legacy system 15 unable to communicate using the more common EJB and CORBA IDL interfaces. The legacy system adapters 65 speak the legacy system protocol, for example, XML message driven protocols, etc. The legacy system adaptors 65 are represented as API interfaces in either CORBA, IDL or EJB formats.

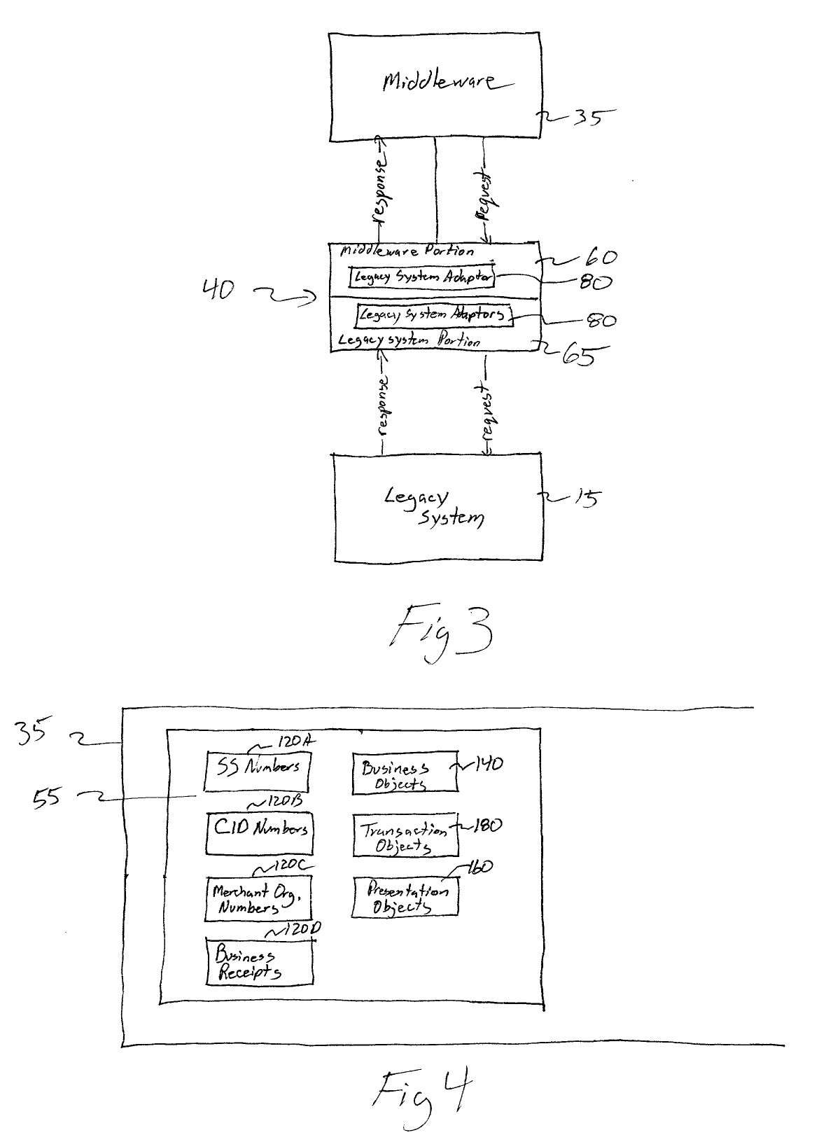

Referring now to FIGS. 2A and 2B, there is illustrated how the API 40 enables interaction between the middleware 35 and a legacy system 15 using either the CORBA and EJB interface 60 or the legacy system interface 65. As shown in FIG. 2A, when the legacy system supports CORBA or EJB interfaces, the middleware 35 and legacy system 15 communicate directly. However, if the legacy system 15 does not support CORBA or EJB interfaces, the legacy systems adaptor 80 must be utilized to enable communication between the middleware application 35 and the legacy system 15.

Referring now to FIG. 3, there is provided a generic illustration of an interconnection between the middleware 35 and a legacy system 15. The API 40 comprises two halves that represent middleware and legacy identification systems, respectively. The middleware portion 60 is part of the middleware application 35. The legacy system portion 65 is a customized portion. The two portions enable each system to utilize each other's functionality. When integrating a legacy system 15, the legacy system portion 65 is unique. The legacy system portion 65 is customized for the particular legacy system 15 with which the middleware 35 is connected. The middleware portion 60 of the adaptor 80 virtually never changes when integrating with a new legacy system 15. The middleware 35 is completely invisible to the legacy system 15 and the same is true for the legacy system 15 with respect to the middleware 35. The middleware 35 and legacy system 15 only “see” the adaptor 80. If the legacy system 15 supports either EJB or CORBA interfaces, then the legacy system portion 65 of the AP1 40 may become obsolete. However, some type of initialization logic may be implemented within the legacy system portion 90. Each API 40, whether interconnecting the middleware application 35 to a business system 15a, transaction system 15b, identification system 15c or presentation system 15d, is configured in the exact same manner. With the middleware portion 60 of the API 40 being virtually unchanged for any application and the legacy system portion 65 uniquely configured to whichever legacy system 15 is being interfaced.

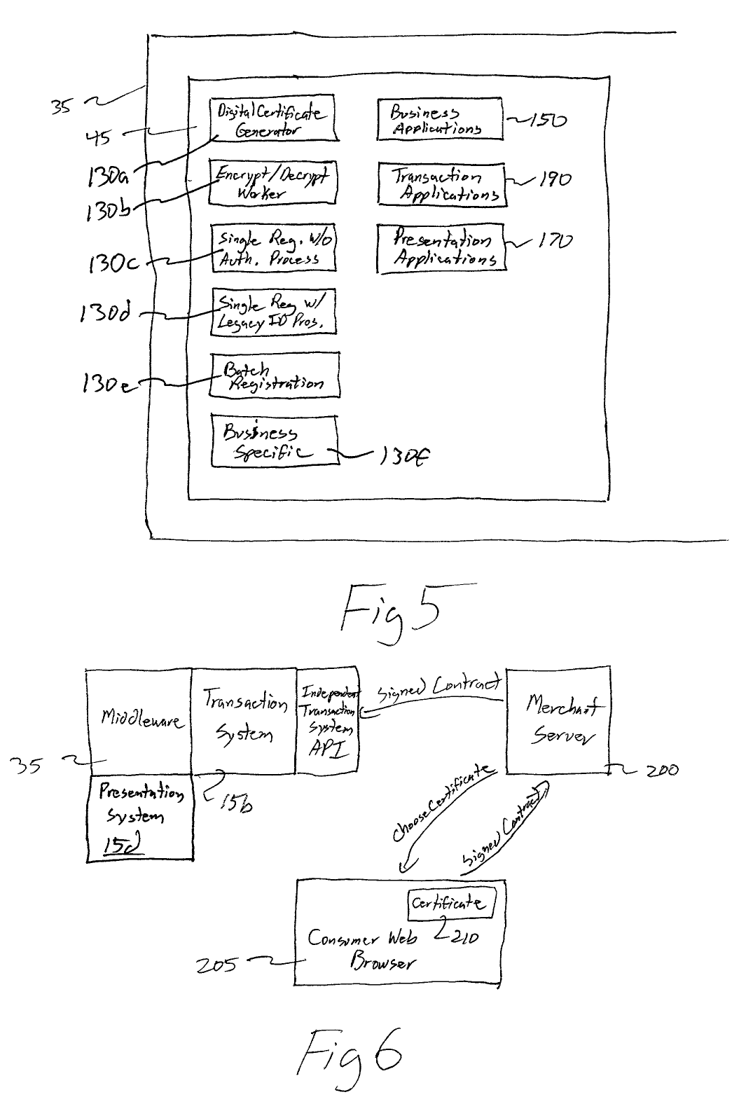

Referring now to FIGS. 4 and 5, there are illustrated the various objects and applications which may be implemented within the middleware 35 in order to provide the middleware 35 with the ability to integrate the various legacy systems 15 into a cohesive electronic commerce system 10. The various objects are stored within the database 55 of the middleware 35. The applications are implemented within the server 45.

With respect to the identification legacy systems 15c the middleware 35 contains identification objects 120 which are mainly identification data used as parameters for any authentication or registration mechanisms. Examples of these types of objects include consumer Social Security numbers 120A; caller ID numbers 120B; merchant organization numbers 120C; business partner receipts 120D, etc. The various applications associated with the identification applications 130 implemented within the middleware 35 include applications that make it possible to manipulate, create, and search data within interconnected legacy systems 15. These include digital certificates generators 130A, encryption/decryption workers 130B, single registration without authentication process 130C, single registration using a legacy identification process 130D, batch registrations 130E, and business object specific applications 130F.

Features provided by the middleware 35 relating to the business legacy systems include business objects 140 relating to consumers, merchants and transactions. Business applications 150 make it possible to manipulate, create and search data between two interconnected systems. The business applications 150 enable updates, the creation of data, the deletion of data searching for particular data or other business object specific functions.

The transaction objects 180 and applications 190 include objects comprising data fetched from various databases and bundled together logically in groups such as consumers, merchants, transactions, accounts and miscellaneous. Applications 190 associated with the transaction system include logic making it possible to manipulate, create and search data between two interconnected systems. Applications 190 may relate to updates, creation of data, deletion of data, searching for data and other business objects.

Features relating to the presentation legacy systems include objects 160 and applications 170 related to the presentation systems. Presentation objects are user-based sessions. Session objects 160 are role-based sessions wherein access to various functionalities is restricted by the role played by the system user. Access can be limited to consumer sessions, merchant sessions, support sessions, or administration sessions. The session applications 170 create tags created specifically to be used in a web environment. The applications 170 available to a user are highly flexible and can be easily redefined via updates, creation and deletion of data, searching, displaying and business object specific functions.

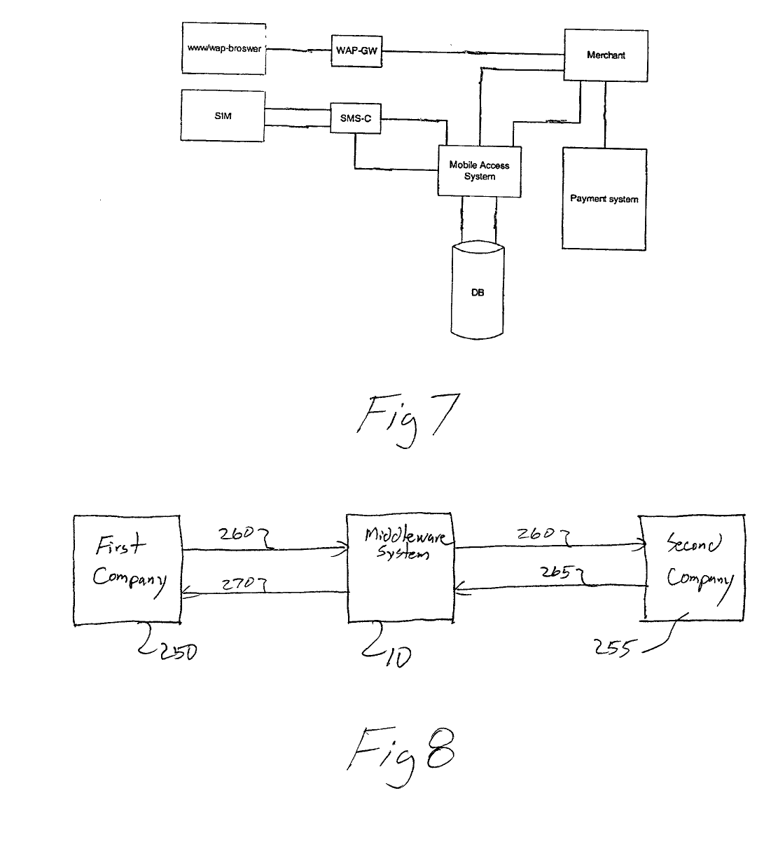

Using the above-described system a number of transactions may be carried in the e-commerce arena. For example, various access methods may be used to confirm on-line purchases from a merchant's web site. Two exemplary methods for confirming on-line purchase involve either browser access (FIG. 6) or mobile access via SMS (FIG. 7). However, it should be realized that the present invention is not limited to these types of confirmation access methods and other types may be implemented. Within the browser access method, a merchant must adopt its own purchase transaction implementation on a web server 200 associated with a presentation system 15d. A verification is performed using the middleware 35. Confirmation is done solely between the merchant web server 200 within the presentation system 15d, the consumer web browser 205 within the presentation system 15d and the transaction system 15b. The exact implementation of the purchase transaction depends upon the transaction system 15b used. The typical implementation involves the use of a digital X509 certificate 210 installed within the web browser 205 of the consumer. Information about the certificate 210 is also stored within the transaction system 15b, and is used to identify the consumer's account in the transaction system 15b when purchases are made. This normally means that purchases can only be made from a computer in which the consumer has a registered account, unless the certificate 210 is exported and copied to another computer. The only active role played by the middleware 35 in this case is for providing access between the presentation systems 15d and the transaction system account 15b. When a consumer decides to purchase an item on a web shop, the consumer is prompted to choose a certificate. A certificate is used to digitally sign a contract which is transmitted to the transaction system via the merchant's web server 200.

Using wireless technologies (FIG. 7), it is possible to verify payments using wireless hand held devices such as a mobile telephone. A mobile access system must be tightly integrated with the payment system. All transactions must be dispatched as quickly as possible to the payment system but be handled in a controlled way through the middleware 35 (not shown). A mobile access system should handle two tasks, sending and receiving SMS messages and acting as a proxy server for account certificates. Merchants would fetch these certificates and use them when communicating with the transaction systems 15b (not shown).

The electronic commerce system 10 of the present invention may also be used in transactions between businesses as is illustrated in FIG. 8. In this example, the electronic commerce system 10 enables the transaction to be dispatched directly between a first company 250 and a second company 255 and acts as a trusted partner between the first company 250 and the second company 255. The electronic commerce system 10 manages the technical issues regarding the dispatch of calls to the correct destination, and insures that the data format is kept constant between the two companies. The electronic commerce system 10 even has the capability of maintaining confidentiality with respect to customer data by rendering it invisible to a requesting party. As a trusted partner, the electronic commerce system 10 acts as an independent party, legally detached from the buyers and the sellers, that ensures that transactions are processed in a controlled manner. The electronic commerce system 10 provides protection from fraud, eavesdropping, and so on. While the present example illustrates an interconnection between only two companies, it should, of course, be realized that many more than two companies could be hooked up in this fashion enabling the exchange of data.

In the example of FIG. 8, first company 250 requests at 260 the authentication of a particular customer and specific data related to this customer to the electronic commerce system 10. The electronic commerce system 10 takes this request 260 and forwards it in the proper format to a second company 255 to request authentication data for this customer. The second company 255 forwards this information relating to the customer at 265 back to the electronic commerce system 10 which provides the information at 270 to the first company 250.

Using the foregoing system, an individual is able to more easily create an electronic commerce system without being required to completely build a system from the ground up. Building blocks from previously existing legacy systems may be utilized within various functionalities required for the electronic commerce system using the middleware 35 such that previously existing resources may be utilized.

The previous description is of a preferred embodiment for implementing the invention, and the scope of the invention should not necessarily be limited by this description. The scope of the present invention is instead defined by the following claims.

What is claimed is:

1. A system for enabling performance of electronic commerce transactions, comprising:
a central controller for integrating a plurality of legacy systems together to enable an exchange of data relating to an electronic commerce transaction; and
a plurality of APIs associated with the central controller for enabling communications between the central controller using a first protocol and the plurality of legacy systems using at least one different protocol.

2. The system of claim 1, wherein the central controller further comprises:
an application server for implementing logic for performing the electronic commerce transaction between the controller and the plurality of legacy systems; and
a database for storing data relating to the electronic commerce transaction.

3. The system of claim 1, further including an API controller for controlling conversions between the first protocol of the central controller and the at least one different protocol of the plurality of legacy systems.

4. The system of claim 1, wherein the plurality of APIs further comprises:
a first layer for supporting the first communication protocol used by the central controller; and
a second layer for supporting a second communications protocol used by a legacy system.

5. The system of claim 4, wherein the first layer supports CORBA and EJB interfaces.

6. The system of claim 4, wherein the first layer supports RMI interfaces.

7. The system of claim 1, wherein the first layer supports MQ interfaces.

8. The system of claim 1, wherein the plurality of legacy systems comprise at least one of business systems, presentation systems, identification systems and transaction systems.

9. A system for enabling performance of electronic commerce transactions, comprising:
a central controller for integrating at least one of business systems, transaction systems, identification systems and presentation systems together with the central controller to enable the exchange of data relating to an electronic commerce action therebetween; and
at least one API associated with the central controller for enabling communication between the central controller using a first protocol and the at least one of the business systems, transaction systems, identification systems and presentation systems using at least one second protocol, the API further comprising:
a first layer for supporting the first communication protocol used by the central controller; and
a second layer for supporting a second communications protocol used by the at least one business systems, transaction systems, identification systems and presentation systems.

10. The system of claim 9, wherein the central controller further comprises;
an application server for implementing logic for performing the electronic commerce transaction between the controller and the at least one business systems, transaction systems, identification systems; and
a database for storing data relating to the electronic commerce transaction.

11. The system of claim 9, further including an API controller for controlling conversions between the first communications protocol of the central controller and the second communications protocol of the at least one business systems, transaction systems, identification systems and presentation systems.

12. The system of claim 9, further including a plurality of objects containing data necessary for performing an electronic commerce transaction by the central controller.

13. The system of claim 9, further including a plurality of applications defining logic for implementing the electronic commerce transaction between the central controller the at least one of business systems, transaction systems, identification systems and presentation systems.

14. The system of claim 9, wherein the first layer supports CORBA and EJB interfaces.

15. The system of claim 9, wherein the first layer supports RMI interfaces.

16. The system of claim 9, wherein the first layer supports MQ interfaces.

17. A system for enabling integration of electronic commerce transactions between transaction legacy systems, business legacy systems, identification legacy systems, and presentation legacy systems, comprising:
a central controller for integrating transaction legacy systems, business legacy systems, identification legacy systems and presentation legacy systems together with the central controller to enable the exchange of data relative to an electronic commerce transaction therebetween;
a first API interface associated with the central controller for enabling communication between the central controller using a first protocol and the transaction legacy systems using at least one transaction legacy system protocol, the first API further comprising:
a first layer for supporting the first communications protocol used by the central controller; and
a second layer for supporting the at least one transaction system protocol used by the transaction legacy systems;
a second API interface associated with the central controller for enabling communication between the central controller using the first protocol and the business legacy systems using at least one business legacy system protocol, the second API further comprising:
a first layer for supporting the first communications protocol used by the central controller; and
a second layer for supporting the at least one business legacy system protocol used by the business legacy systems;
a third API interface associated with the central controller for enabling communication between the central controller using the first protocol and the identification legacy systems using at least one identification legacy system protocol, the third API further comprising:
a first layer for supporting the first communications protocol used by the central controller; and
a second layer for supporting the at least one identification legacy system protocol used by the identification legacy systems;
a fourth API interface associated with the central controller for enabling communication between the central controller using the first protocol and the presentation legacy systems using at least one presentation legacy system protocol, the fourth API further comprising:
a first layer for supporting the first communications protocol used by the central controller; and
a second layer for supporting the at least one presentation legacy system protocol used by the presentation legacy systems.

18. The system of claim 17, further including an API controller for controlling conversions between the first communications protocol of the central controller and a second communications protocol of each of the business legacy systems, transaction legacy systems, identification legacy systems and presentation legacy systems.

19. The system of claim 17, wherein the second layer of each of the first, second, third and fourth application program interfaces include CORBA and EJB adaptors enabling communication with EJB interfaces and CORBA IDL interfaces.

20. The system of claim 17, wherein the second layer of each of the first, second, third and fourth application program interfaces include legacy system adaptors for enabling communication with an associated legacy system protocol.
